(19) United States
(12) Patent Application Publication
(10) Pub. No.: US 2003/0195845 A1
(43) Pub. Date: Oct. 16, 2003

(54) Method of conducting business among entities participating in a system for distributed network authentication, access and aggregation

(76) Inventors: Francis M. Anton JR., San Jose, CA (US); Phil Alfaro, San Francisco, CA (US); Steven D. Cochran, La Jolla, CA (US); Clark Dong, Saratoga, CA (US); Kym M. Donovan, San Francisco, CA (US); Sandeep Sardana, Fremont, CA (US)

Correspondence Address: Pillsbury winthrop LLP, 1600 Tysons Boulevard, McLean, VA, 22102, US

(21) Appl. No.: 10/124,172

(22) Filed: Apr. 16, 2002

(51) Int. Cl. G06F 17/60

(52) U.S. Cl. 705/40

(57) ABSTRACT

What is disclosed is 1) effective aggregation of both wireless and wireline networks and consumers of services based on these networks, 2) the introduction of this aggregated network footprint to the aggregated consumer base, and 3) the exchange and/or resale of services to these consumers in order to obtain a profit. This is implemented by deploying a service which acts as an interchange and gateway for various Network Service Providers, Billing Service Providers, network locations and their users.

### BACKGROUND

1. Field of the Invention

The invention relates generally to network usage management. More specifically, the invention relates to methods for managing and administering wireless networks and services carried thereon that can be accessed by mobile users.

2. Related Art

The popularity of the Internet has made a vast amount of information readily available to anyone with an Internet connection. Internet-enabled electronic mail has become an essential form of business communication. Currently, connections to the Internet are predominantly made with landline access links such as dial-up modems, digital subscriber lines, and cable modems.

These types of connections, although pervasive, offer limited mobility to a user and make the sharing of an Internet connection difficult. For example, many libraries offer Internet access at dedicated computer terminals and some universities provide network access jacks at multiple buildings on their campuses for convenient access by students using laptop computers. Both of these approaches offer a means for accessing the Internet at locations other than one's own landline access link, but both require that one remain stationary at the publicly-provided access point and both require a substantial infrastructure investment on the part of the institution providing the network connection. Since it is not generally possible to have multiple users sharing the same network access jack or dedicated terminal, the institution must provide a separate access point for each patron it wishes to service. Additionally, those institutions offering access jacks to their network, such as universities, typically require that the user have a registered network account before being given access to the network, which further limits the network's accessibility to the public.

Similarly, when a vendor visits a customer site on whose computer network the vendor does not have an account, the vendor will find it very difficult to gain access to the network, and hence to the Internet, email accounts, and other vital data. Should the vendor be fortunate enough to gain access to a network jack, the vendor will still be at the mercy of the customer site's network administrator. For security reasons, it is customary for companies to set up their computer networks to deny access to anyone not already present in their access list of registered users.

Thus, mobile access to the Internet is limited by two factors. The first is the physical requirement for a user to maintain a line connection to sparsely located network access jacks. The second is the difficulty in gaining access to a network on which one does not have a registered account. The first of these factors has begun to be overcome by the introduction of wireless data networks, which do not require that a user maintain an access line plugged into a network access jack and thus do not require that the user remain stationary. Additionally, because the network connections are made wirelessly, it is relatively easy for multiple users to connect and disconnect from a network using the same access point. Overcoming the second factor is not so straightforward, and is addressed more fully below.

An example of a currently widely available wireless data network is the low speed personal communication service (PCS) network. The primary access devices of this type of network are cellular telephones with built-in Wireless Application Protocol (WAP) features. These wireless networks operate in a licensed frequency band, are centrally planned, and are built by large telecommunication carriers. Typically, each cell has a large radius of about 2-10 miles and operates at a slow speed of about 19 Kbps. In any given geographical region there are only a handful of telecommunication carriers servicing the area, and each network is proprietary and closed to competing networks. Thus, to some degree one is not free to roam from one network to another. Additionally, their slow speed makes full access to the Internet impractical and such network devices are typically restricted to abridged textual displays.

An emerging new class of wireless data networks offer higher speeds of about 1-11 Mbps. These networks operate in an unlicensed frequency band and are based on emerging wireless communication protocol standards such as IEEE 802.11, Bluetooth and homeRF. A common characteristic of these types of networks is a small cell radius of about 200 feet. The cells are radio or infrared base stations that function as access points (APs) to a network. Several of these access points may be distributed in close proximity to each other to expand the overall range of this type of wireless network. An introduction to such networks can be found in U.S. Pat. Nos. 5,771,462 and 5,539,824.

Various network configurations may be formed using these types of wireless network devices. FIG. 1 shows multiple computers 11 to 17 equipped with wireless network radio devices characterized by respective antennas 19 through 25. When computers 11 through 17 are within close proximity to each other, they can form a type of ad hoc network and communicate among themselves. Absent from this type of ad hoc network, however, is a base station cell that can connect their ad hoc network to a wireline network having landline access to the Internet. Therefore, this type of ad hoc network does not have access to the Internet.

With reference to FIG. 2, in order to access the Internet, one needs to gain access to a network having a router 37 which in turn connects the network to the Internet 35. These types of networks are typically characterized by a server 31 which controls access to various services on the network, including Internet services. Workstations 33 connect to the server 31 by means of various types of hardware cabling media 53. The network may provide wireless access points 41 and 43 to respectively couple computers 47 and 49, which are equipped with wireless communication devices illustrated as antennas, to the hardwired network controlled by server 31. The access points 41 and 43 establish wireless connections with computers 47 and 49 by means of various communication systems such as radio and infrared waves, and have a hardwired connection to server 31 along cable 53. The function of access points 41 and 43 is to relay communication between server 31 and wireless network computers 47 and 49 respectively, but server 31 still controls what services are provided to computers 47 and 49. Thus, server 31 may deny Internet services to computers 47 and 49. Indeed, server 31 may refuse computers 47 and 49 entry to the network if they do not already have network accounts registered with server 31.

As was stated above, wireless networks have a short range, and so a second access point 45 may be used to function as a repeater between a more distant wireless network computer 51 and access point 43. This is an example of using multiple base station access points 43 and 45 to extend the range of a wireless network.

With reference to FIG. 3, many network layout configurations are known, and server 53 need not be located between a router 55 and the other network nodes 61 to 65. In the network layout of FIG. 3, access point 67 has direct access to router 55, which in turn has access to the Internet 59, but this does not mean that server 53 loses its control over the network. Regardless of the layout, server 53 may still be in charge of authenticating new users and assigning resources. Again, access point 67 is illustrated as a wireless access point due to its convenience in permitting multiple users 61 to 65 easy access to the network, but other hardwired access point connections are likewise typical.

In spite of their convenience, such wireless networks have been prohibitive in the past due to their relatively high costs. Until recently, the components required to implement a wireless network had been costly, but recent developments in technology have begun lowering the price of both the cell base stations and radio devices needed to implement a wireless network. Such wireless networks are now becoming more prevalent in the industry, and many small businesses may operate their own autonomous wireless networks. The size of these autonomous wireless networks could range from a city block, to a small building, to a coffee shop. It would then be possible for a mobile user to always have access to a wireless network by means of a mobile computing device equipped with the proper radio communication devices. Thus, this type of wireless network would overcome the first factor limiting the free and mobile access to the Internet discussed above.

Nonetheless, one is still faced with the second factor mentioned above which restricts mobile access to the Internet. Since most autonomous wireless networks are independent, a mobile user would typically not be given access to a target network unless an access account had been setup ahead of time for the mobile user on the target network. Even if a user had access accounts at multiple wireless networks, the user would have to stop his activities and re-authenticate on a different wireless network every time he moved from one autonomous network to another.

Some prior art can be found in the areas describing methods of accessing foreign networks and methods of implementing multiple network transfers. U.S. Pat. No. 5,878,127, for example, shows a telephone system that facilitates remote access to a private network from non-network locations or stations. The system authorizes remote access to the private network based on a calling party number of the non-network station and/or an authentication code entered by the remote calling party. U.S. Pat. No. 6,016,318 describes various method of providing access to a private LAN and to the Internet via a “public mobile data network” including a location register, which serves as a database for storing location information of mobile data terminals and subscriber information. Along a similar note, U.S. Pat. No. 5,978,373 shows a method by which a remote user can gain secure access to a private WAN. A central authentication office acts as a proxy to authorize a remote user and establish a secure connection to the private network. The central office sends the remote user a service registration template HTML file to be filled by the remote user. Once the remote user has been authenticated, a connection is made with the private network. Similarly, U.S. Pat. No. 5,918,019 shows a system by which a remote user can establish a simulated direct dial-up connection to a private network via the Internet.

U.S. Pat. No. 6,000,033 describes a system wherein a user has accounts in multiple databases with different passwords in each of the databases. To access all of the databases, the user logs on to a master password database which then submits the appropriate password to whichever database the user wishes to access. U.S. Pat. No. 5,872,915 shows a method of permitting secure access to software on a web server via the Internet. A user enters data via a web browser, which is communicated to the web server application. The web server application then authenticates the web browser, and passes appropriate input data to an application gateway, including data to uniquely identify the web browser. The application gateway then uses authentication data received from the browser to determine whether the user of the browser is authorized to access the software application. U.S. Pat. No. 5,805,719 describes another method of authenticating a user wherein the system forgoes the use of ID tokens in favor of authorizing transactions by using the correlative comparison of a unique biometrics sample, such a finger print or voice recording, gathered directly from the person of an unknown user, with an authenticated biometrics sample of the same type obtained and stored previously.

With the proliferation of network service providers who provide everything from Internet access to customized content, there is a disconnect between the network service providers and all of the potential APs that may exist in hotels, coffee shops, small businesses and so on. Primarily, while a small business or other such entity would not have the expertise or desire to maintain a full wireless network, they maintain a simple router-less and server-less network “hub” which serves as a wireless access point to customers and others within the confines of its building. Since the AP is wireless, it would be difficult, if not impossible, for the small business to monitor and track the usage of the AP. Furthermore, the network service providers would also have difficulties in that they would have to establish relationships with every small business that operates such a wireless network. Since there are many such service providers as well, and new wireless networks can spring up at anytime, the problem of offering users universal mobile wireless access becomes problematic. For instance, if a user has a an access account with network service provider A and the user travels to a coffee shop that does not have an account with service provider A, access through that service provider would be unavailable. While a network service provider B with whom the coffee shop has an account could provide access to the user, this implies the user must sign up with that network service provider.

Often the service providers themselves are not the ones that have direct relationships with the users. Other intermediaries, known as billing service providers, establish accounts with users. The users pay the billing service provider and the billing service provider reimburses the actual network service provider. Since there are many such network service providers and many billing service providers, the problem of coordinating and integrating these with all of the possible small wireless APs becomes unmanageable.

### SUMMARY

In its various embodiments, the invention involves enabling 1) effective aggregation of both wireless and wireline networks and consumers of services based on these networks, 2) the introduction of this aggregated network footprint to the aggregated consumer base, and 3) the exchange and/or resale of services to these consumers in order to obtain a profit. The invention is implemented by deploying a service which acts as an interchange and gateway for various Network Service Providers, Billing Service Providers, network locations and their users.

### BRIEF DESCRIPTION OF THE DRAWINGS

FIG. 1 is a prior art depiction of an ad hoc network using wireless communication.

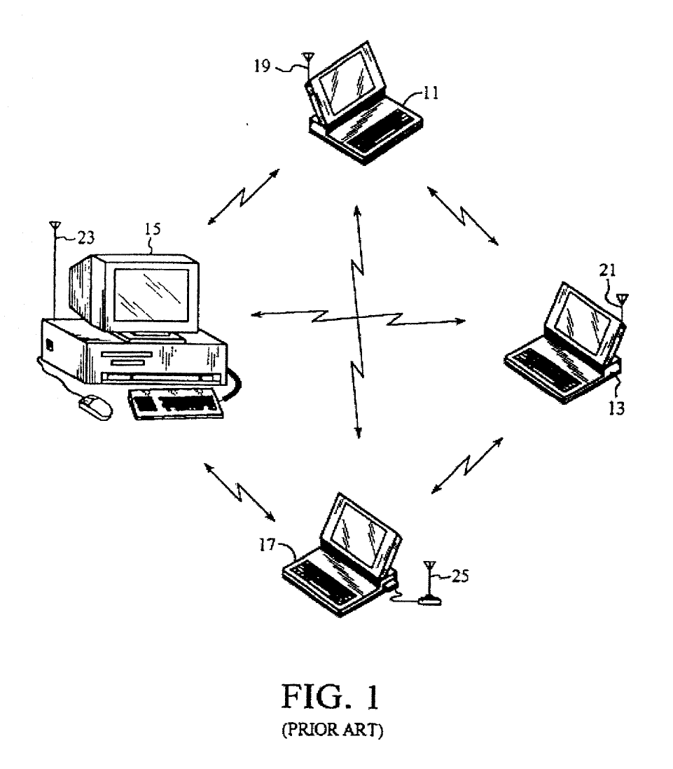

FIG. 2 is a first prior art network layout using both wireline and wireless network connections.

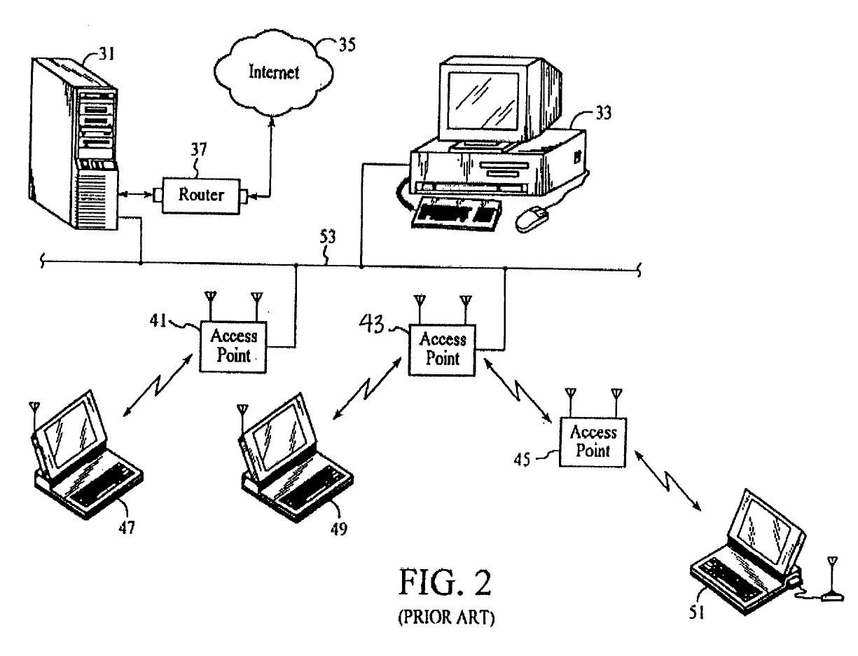

FIG. 3 is a second prior art network layout using both wireline and wireless network connections.

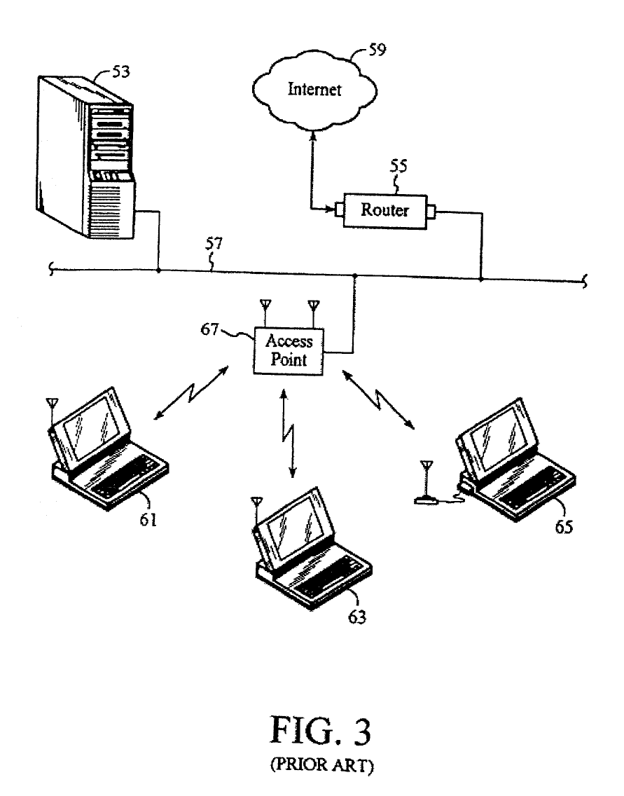

FIG. 4 is an overview of at least one embodiment of the invention.

FIG. 5 illustrates classes of entities serviceable by a BSAA service according to one or more embodiments of the invention.

FIG. 6 is a detailed view of features and functions in a BSAA Service according to one or more embodiments of the invention.

FIG. 7 is a flow diagram of the NSP business process according to one or more embodiments of the invention.

FIG. 8 is a flow diagram of the BSP business process according to one or more embodiments of the invention.

### DETAILED DESCRIPTION OF THE INVENTION

In brief, the invention consists of enabling 1) effective aggregation of both wireless and wireline networks and consumers of services based on these networks, 2) the introduction of this aggregated network footprint to the aggregated consumer base, and 3) the exchange and/or resale of services to these consumers in order to obtain a profit. The invention is implemented by deploying a service which acts as an interchange and gateway for various Network Service Providers, Billing Service Providers, network locations and their users.

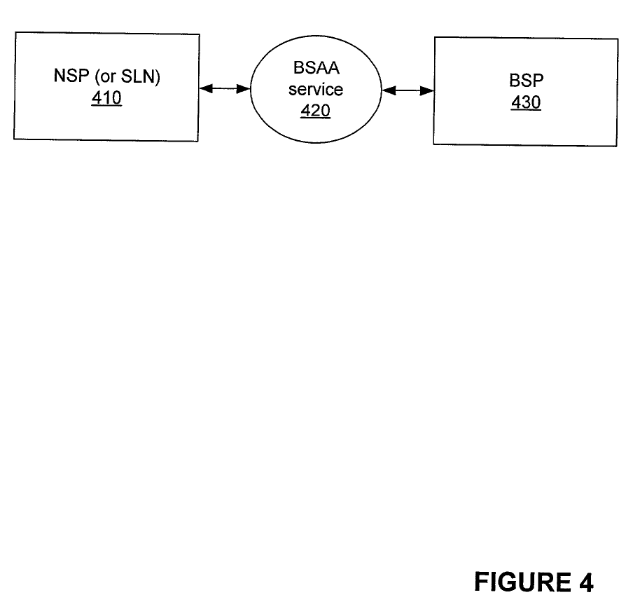

FIG. 4 is an overview of at least one embodiment of the invention. A network service provider (NSP) 410, as used in this detailed description, refers to a large class of network access and content providers such as Mobilestar™ which operate and deploy wireless and wireline communications lines and networks. The NSP 410 may be a provider who owns physical access media such as DSL (Digital Subscriber Lines) or satellite-based systems. The NSP 410 may include telephone companies, or CLECs (Competitive Local Exchange Carriers), and the like. The NSP 410 provides access through its owned assets to other entities, such as content and access providers (for instance, AOL (America Online)) which may act as a billing service provider (BSP 430).

The invention, in various embodiments, acts to aggregate and intermediate the relationship between BSPs such as BSP 430 and NSPs such as NSP 410 as they relate to each other and to end users of their services. In one embodiment, the invention consists of a Billing, Settlement, Access and Aggregation (BSAA) service 420 which provides NSP 410 and BSP 430 with a wide variety of hassle-free services and functions, including means of interacting more dynamically with their remotely located users. BSAA Service A40 may be a centralized system, a distributed system, or as individual components and may be implemented in hardware, software, firmware or a combination of these. The BSAA service 420 is maintained by a single, trusted, third-party entity, and thus, integrates the entire business cycle of wireless information access. Further, by offering globally accessible authentication services, the BSAA Service also enables users to have network service provider access at arbitrary locations, allowing the user to roam indefinitely from location to location without worry of being without access. The BSAA service 420 expands roaming access to a vast array of public locations, than could typically be serviced economically or practically.

The business model of the BSAA service 420 involves collecting transaction fees from the NSP 410 and/or the BSP 430 for transactions with users that access a wireless network. The types of services offered by BSAA 420 are four in nature: 1) Access 2) Billing 3) Settlement and 4) Aggregation.

Access

While not necessarily owning the media providing the access, BSAA service 420 provides a distributed authentication service to any user of a wireless service. The entire wireless session begins with an end user entering what is known as a “Single Location Network” (SLN), such as a coffee shop or other small business in which IT network management/ownership is not part of their core business. Another way for users to enter the system is by entering the network of a dedicated NSP such as Mobilestar™. In describing this and the various embodiments of the invention, the terms “SLN” and “network location” are used synonymously to indicate either a single access point contained within a business and/or a roamable network area serviced by a NSP. Users sign up with BSAA service 420 either in advance or at the SLN itself. The SLN or perhaps an NSP maintains an internal wireless or even wireline (such as Ethernet) local area network that allows the user to connect his/her laptop or other information device to an AP (Access Point). The AP links the SLN with a network service provider offering Internet access, for instance. Before the user gets onto the wide, unrestricted Internet, the user is first authenticated through the BSAA service 420. A co-pending U.S. Patent Application, entitled “System for Distributed Authentication and Access Control”, filed on Aug. 1, 2000, describes the workings of such an authentication. If the user does not have an account with BSAA service 420, the user is allowed guest access for the purpose of establishing such an account. Once the user is authenticated, a real-time accounting “call” record is maintained by the BSAA service 420. BSAA service 420 then allows the user unrestricted access over the Internet or other network with which the user has a pre-existing account. This authentication scheme does not require the user to have a pre-existing relationship with either a BSP or NSP, and can establish such a relationship on behalf of the user automatically. If the user has a pre-existing relationship, the relationship is noted in the users profile. The access to the Internet is fully distributed, as long as the SLN or even, NSP supplying the network, are affiliated with the BSAA service 420.

Billing

While the user is logged in and accessing the network, the real-time accounting call record will tally various metrics, like seconds used, bytes used, packets transmitted, etc., in order to facilitate billing for service consumption, and based on the AP through which is connecting, determine the physical location of the user. When the user logs off, the call record is closed. The various metrics for the user (such as average session time) can be stored in the user's profile and simultaneously, the call record can be passed to a BSP or NSP as appropriate. At the end of a billing cycle, for instance at month's end, all of the calls through each NSP are tabulated. Each of the affiliated NSPs, SLNs and BSPs gets a summary record of the usage, and accounts payable and receivable invoices as appropriate. For instance, for a given NSP, the activity can be broken down by user, by accessed network location and by BSP. Likewise, the statement of activity for a BSP can be broken down by user, NSP and network location.

Settlement

Through an internally controlled settlement mechanism, the BSAA service 420 collects a net usage fee from each of the affiliated users or from the BSP every month/billing cycle. The BSAA service 420 extracts a transaction fee for the services provided to the BSPs, NSPs and SLNs. The fee may be fixed-per-user or entity or may be a percentage of the usage fee, depending upon the arrangement entities have made with the BSAA service 420. The BSAA service 420 then pays the NSP or SLN from the proceeds received from the BSP and/or users. In this manner, the NSP does not change the way it operates, and in fact, simplifies its collection process. As mentioned above, in one embodiment, the BSPs may collect from the users based upon the net usage statistics maintained by BSAA service 420. In such cases, the BSAA service 420 would collect the money from the BSPs at the wholesale rate, and pay this wholesale rated amount to the NSPs. The BSAA service 420 takes its transaction fee for the settlement, if such has been arranged by the entities. The NSP or SLN also gets paid for allowing the user to access his local wireless network. The payment to the NSP or SLN will also be from proceeds collected from the users and/or from the BSPs.

Aggregation

Unlike aggregators who buy access time (bandwidth) mark it up and then resell it to service providers, the BSAA service 420 allows BSPs to set the retail rates, NSPs to set the wholesale/retail rates and the BSAA service to simply passes the retail rates on to the end customer. The BSAA service 420 then takes a transaction fee from the BSPs and/or NSPs directly as a by-product of end customer usage. They need only have a relationship with the third-party entity controlling and administering the BSAA service 420 and if desired, a relationship with the end customer (which can be established through the BSAA service 420 upon attempted access at an SLN by the end customer). Aggregation also refers to the aggregation of all the end customers who have accounts with a given BSP or NSP rather than the BSP or NSP billing and collecting each individual end customer for their usage,

Additional Features

Since BSAA service 420 knows which BSP and/or NSP is associated with a given customer access session, the BSAA service 420 can forward or provide customized content to the end customer. For instance, if an NSP wishes to push content, such as an end customer's start page, whenever and wherever the customer gains access, the BSAA service 420 can forward such content (e.g. HTML (HyperText Markup Language) pages) to the end customer after the end customer is authenticated and given network access. The customized content can also be varied to account for the physical location of the end customer. For instance, when an end customer roams from a different city than his home, the BSAA service 420 will automatically recognize the location (because it has knowledge of which network location the end customer is attempting access from) and send the user content pertinent to that location, such as weather.

Further, BSAA service 420 enables a real-time auctioning and arbitrage mechanism that can deliver the best available price or quality of service for access sessions. For instance, when an end customer has an account with a BSP, the BSAA service 420 can institute a real-time reverse auction querying all participating NSPs for the lowest available wholesale rate. The BSP can set its retail rate to end customer as variable, based upon the obtained wholesale rate, or fixed, in which case, it would gain a margin advantage. The BSAA service 420 can also track different rates based on quality-of-service or type of service desired. For instance, where an end customer desires Voice-over-IP service, the BSAA service 40 can rate session records at a higher service charge then for data services only.

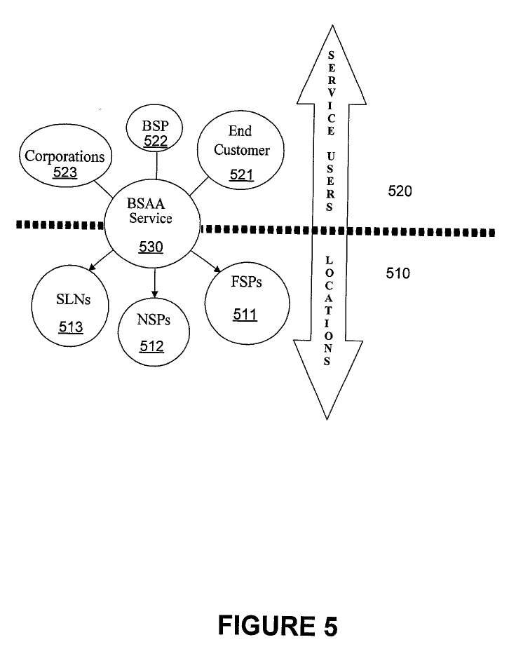

FIG. 5 illustrates classes of entities serviceable by a BSAA service according to one or more embodiments of the invention. The schema of entities serviced in accordance with the invention may be conceptually divided in two classes-service users 520 and service locations 510. The types of service locations 510 include SLNs (Single Location Networks) 513, NSPs (Network Service Providers) 512 and FSPs (Full Service Providers) 511. The service users 520 include Corporations 523, BSPs (Billing Service Providers) 522 and End Customers 521. All of these entities virtually interact by making use of a BSAA Service 530, which is similar in function, feature and operation to BSAA service 420 described above with respect to FIG. 4.

Locations 510 refer to entities that own physical assets that are directly involved in end customer mobile/remote/wireless networking sessions. For instance, SLNs 513 are small businesses (such as restaurants and coffee shops), hotels, airports or other buildings and designated areas that offer a wireless LAN (Local Area Network) via one or more APs (Access Points). The SLNs 513 allow end customers 521 and other service users 520 to connect to a network via the APs using dumb terminals, computers, handheld information devices (such as PDAs (Personal Digital Assistants) and cell phones) and the like. SLNs 513 may 1) own its own terminals or computers which may be connected to the APs either wire-line (e.g. via Ethernet cable) or wireless (e.g. via IEEE 802.11); and/or 2) have terminal jacks or wireless APs that allow an end customer to connect to the AP using their own computers and portable devices. In either case, the SLNs 513 would need to maintain servers/meters that track usage through the AP or offer connectivity in a free, unlimited fashion. Instead of the former case, the BSAA service 530 assumes those roles and provides SLNs 513 with a seamless fee generation capability. The SLNs 513 do not need to maintain any accounting, monitoring, metering or billing, and do not even need a relationship with the end customers. The BSAA service 530 sends the fees for the usage of their facility by all end customers to the SLNs 513 every billing cycle.

NSPs (Network Service Providers) 512 include Internet backbone providers, metropolitan carriers, CLECs (Competitive Local Exchange Carriers), telephone companies, cable companies, DSL companies, and other such entities that own access lines to the Internet or leased lines that bridge together private network(s). Using BSAA service 530 NSPs 512 can sell their access availability/capability (also called bandwidth) directly or indirectly to End Customers 521 roaming at SLNs 513. In some instances, the NSPs 512 may sell its bandwidth to SLNs 513 in bulk (for instance, offering a guaranteed total bandwidth to the SLN at a periodic rate), which then in turn offers access to the bandwidth to end customers 521 using their establishment. Additionally, the NSPs 512 may enable BSPs 522 to become virtual providers of network service by selling its bandwidth at wholesale rates to the BSPs 522 who in turn charge retail rates to End Customers 521. In either case, the maintenance of rates, payment of fees, monitoring of usage, and general transaction management is handled by the BSAA service 530.

FSPs (Full Service Providers) 511 have physical, infrastructure-type assets as well as direct billing relationships with End Customers 522. In this way, FSPs act as a combined NSP and BSP. The BSAA service 530 manages the relationship between FSPs 511 and SLNs 513 and can manage the relationship between FSPs 511 and End Customers 522 (for instance, by helping new customers of the FSPs 511 to sign up, delivering location-based content etc.).

Service users 520 include at least three types of entities-Corporations 523, BSPs 522 and End Customers 521. Corporations 523 include companies and large business entities of all types as well as organizations, public and private, which may have their own private network (intranet) which is dedicated to and secured for access by individuals affiliated and authorized therewith, such as employees. When an authorized user of an intranet attempts to gain access to the intranet while roaming (i.e. outside the intranet), corporations can either grant full/limited access through a secure channel on a public network (such as that enabled by Secure HTTP (Hypertext Transport Protocol)) or through a dedicated direct connect.

BSPs 522 are service users 520 in the sense that they will most likely piggyback or resale the actual access services provided by NSPs 512. The BSPs 522 will likely be the entities that have the most customer visibility and operate to consolidate for a user many types of services, such as long distance, cellular telephone service, modem-based internet access etc., while not necessarily physically owning the lines that provide such services. For instance, AOL™ (America Online) is a service that maintains a billing and account management relationship with customers to whom it offers services such as Internet access, e-mail and so on. However, such service organizations may or may not own the lines which allow users to connect in order to get Internet access. These may instead be owned by NSPs 512. The BSPs 522 use BSAA service 530 to obtain wholesale rates, to obtain access for its customers, to collect fees for such access, to pay the NSPs for access given its customers, and so on. This broad range of services, including customized content pushing, are handled by the BSAA service 530 with minimal participation by the BSPs 522. The accounts with end customers 521 can also be maintained, if desired, by the BSAA service 530.

The End Customers 521 also benefit from affiliation with BSAA Service 530. The End Customers 521 include individuals such as the causal coffee shop laptop holder or business traveler who may be mobile. End Customers 521 may also include home or office users of a wireless or wireline network service. End Customers 521 do not need accounts with more than one BSP and can truly roam from one network location to another without such multiple accounts. End Customers 521 are automatically signed up on BSAA service 530 whenever they first attempt access through a network location affiliated with BSAA Service 530. Once signed on, the BSAA service 530 handles all future authentications and access grants. The End Customers 521 can thereafter gain access to services at any SLN, whether or not that SLN is affiliated with the BSP that they belong to, provided however, that such SLNs and BSPs be affiliated with the BSAA Service 530. The End Customers 521 thereafter are authenticated through to their desired service by first accessing and being authenticated on BSAA Service 530. Further, the End Customer can be given a running total of usage in real-time, taking into account access sessions at any of the SLNs they may have roamed at.

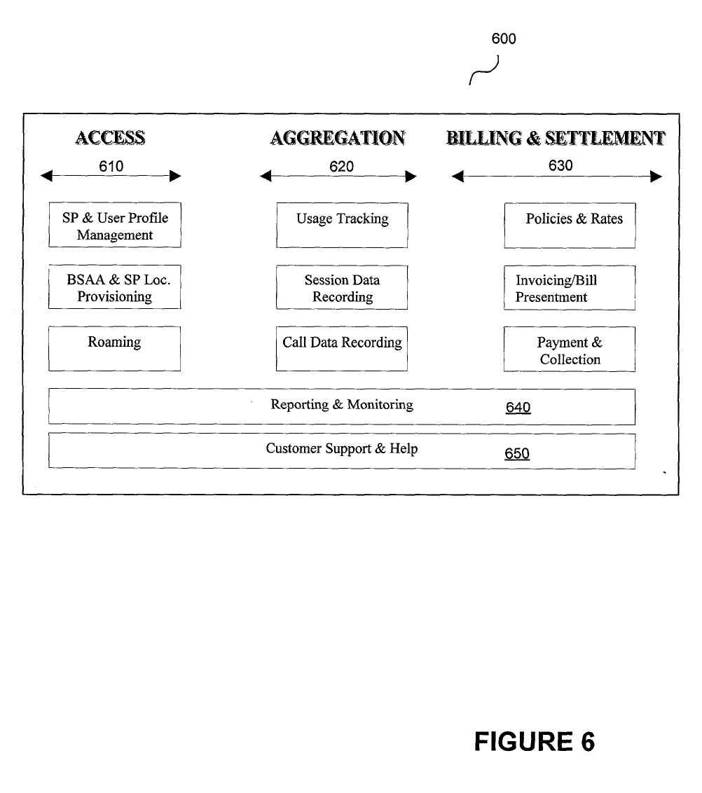

FIG. 6 is a detailed view of features and functions in a BSAA Service according to one or more embodiments of the invention. Three broad categories of features offered by BSAA Service 600 include: Access 610, Aggregation 620 and Billing & Settlement 630. Access 610 includes SP (service provider) & User Profile Management, BSAA & SP Location Provisioning and Roaming. Aggregation 620 includes Usage Tracking, Session Data Recording, and Call Data Recording. Billing & Settlement 630 includes Policies & Rates, Invoicing/Bill Presentment and Payment & Collection. Additional features which broadly span these categories include Reporting & Monitoring 640 and Customer Support & Help 650.

Within the category Access 610, SP & User Profile Management is the feature maintaining and allowing updating of profiles for users (such as End Customers, Corporations etc.) and service providers (such as NSPs and SLNs). Profiles for users include contact information, login ids, passwords, preferred provider lists and so on. Profiles for service providers include rates, methods of payment accepted, availability and types of service, billing parameters, and authentication information. BSAA & SP Location Provisioning includes functions and features related to enabling and disabling SLNs and other locations for particular NSP. Roaming includes functions related to remote authentication, authorization, aggregation, real-time session tracking, notification of roaming charges, surcharges, and location policies. Within category Aggregation 620, Usage Tracking is the function responsible for aggregating the total network usage per end customer, per SLN, per NSP, per BSP etc. for a given time period. Usage Tracking at its most basic tracks the session time of each end customer user and aggregates all the end customers access time for a given SLN or NSP/BSP. Usage Tracking alleviates the BSP/NSP/SLN from having to track usage of its services, and allows them to concentrate on the provision of service rather than the monitoring of it. Special usage sessions such as those involving Voice over IP, may be tracked separately. Further, Usage Tracking can monitor fraudulent activity and QOS (Quality of Service) issues.

Also within category Aggregation 620 are Session Data Recording and Call Data Recording. Whole Session Data Recording is record keeping of users session duration, start, stop, location logged in from, and owner BSP, on the other hand Call Data Recording is record keeping of rated Session Data Records.

Billing & Settlement 630 is a combined category of Billing and Settlement, which can be considered as interdependent functions of a BSAA Service. The Policies & Rates function includes the maintenance and application of wholesale and retail and special usage/QOS rates. The Policies & Rates also functions to set settlement, billing frequency, pre-pay, and authorization policies that may be particular to a given NSP or BSP. The location specific policies may also disallow downloading of certain content and prevent visits to select web sites.

Billing & Settlement also includes Invoicing and Bill Presentment which can be done in a variety of ways, such as through EDI (Electronic Data Interchange), XML (Xtentisble Markup Language) documents or manually, whichever forms of communication are desirable to the NSP/BSP. This data cam be transmitted securely over the Internet to ease the difficult and increase the timeliness of disseminating this data. Payment & Collection functions to manage the settlement features of the BSAA service such as collecting fees from the BSP and paying the shares of collected fees to the NSPs and SLN.

Reporting & Monitoring 640 is a feature of the BSAA service that available across nearly all other functional categories. Reporting on usage, profile updating, rate changes, late payment problems, and on availability of new service providers and SLNs is handled by Reporting & Monitoring 640. Reporting & Monitoring 640 includes monitoring of unauthorized or excessive usage as well as monitoring of service changes, downtime, and access problems.

Customer Support & Help 650 can also be provided by the BSAA Service across all functional categories. Customer Help & Support may be online, by way of e-mail, FAQs, web based knowledgebase or telephone.

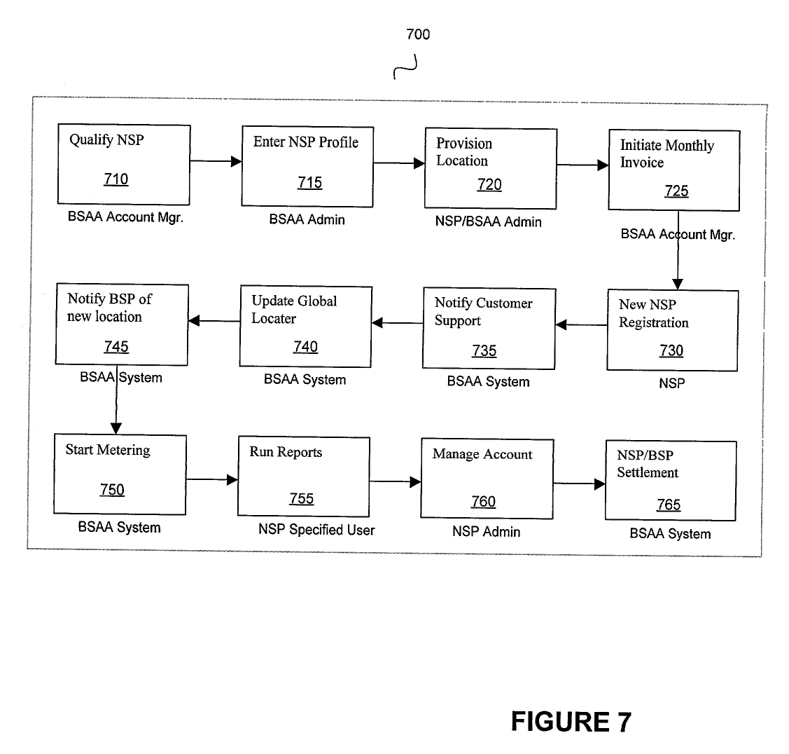

FIG. 7 is a flow diagram of the NSP business process according to one or more embodiments of the invention. The NSP business process 700 describes roughly how an NSP becomes affiliated with a BSAA service and what business cycle the NSP can expect thereafter. Process 700 also shows who would be ideally suited to executing each stage of the process. First, for an NSP to become affiliated with the BSAA service, it must Qualify (stage 710). Qualifying an NSP is function performed by a BSAA service account manager. Qualifying an NSP involves a sales approach (such as call or visit) by a salesman or account manager in the BSAA service. The account manager then evaluates the ability of the NSP to operate in the environment controlled by and with the entities managed by the BSAA service. After such an evaluation, the NSP and BSAA service enter into a contractual agreement, placing it thereafter into “affiliation” with the BSAA service.

After becoming contractually affiliated with the BSAA service, the NSP's profile is entered (stage 715). A new NSP record can be created in the database, and a message sent to the NSP regarding login/updating procedures with respect to their profile record. The NSP can thereafter enter information into its profile using the established record and/or this information can be updated by the account manager at the BSAA service. The NSP must provide the wholesale rate(s) for its service, the format and transfer instructions for call detail records, and settlement information. The NSP profile also includes “user” administration of admin console accounts such as “installers” who provision locations, “basic” who can run select reports, and “admin” who manage most functions related to service provider profile management and request for all reports.

Once profile entering/changing is enabled, then location provisioning functions are initiated (stage 720). Location provisioning involves parameters such as MAC (Media Access Control) addresses, IP address, location's physical address and contact information, rates, transaction center IP address, activation/in-service dates, and other security information. Once a location is loaded as being provisionable, the location has an updateable profile of information created for it which includes status of the location (active, inactive, disabled etc.), and a list of parameters used in performing a validation check, such as MAC addresses, rates, activation/in-service dates, security keys, lists of authorized users, description/location/addresses of the Access Point (AP) and so on. A provisioned location can also have grouped its APs into categories of its choosing if more than one AP exists.

The provisioning of a location (stage 720) thereafter allows and active location to begin transacting with end customers and other users. Based on the sessions transacted, the BSAA service generates a monthly/periodic invoice (stage 725) which includes line items such as charges for the number of APs as well as charges for authorizations through the APs. The monthly invoice will also include typical billing information such as notification of past due accounts, late payment penalties, history of past payments etc.

At any time, a non-solicited NSP should have a means of registering with the BSAA service when needed or desired (stage 730). The new NSP wishing to qualify would forward basic information to a BSAA account manager which would then qualify the NSP or not qualify the NSP. If an NSP is qualified, stage 730 would include a repetition of stages 715, 720 and 725 for the newly qualified NSP. The recursive procedure implicit in a new unsolicited registration is not explicit in FIG. 7 but should be evident to one of skill in the art in light of the above description.

Stage 735 in the business process notifies customer support at the BSAA service that a new NSP has become affiliated, allowing customer support to access profile information relevant to the NSP in order to better service them. Stage 740 involves updating a global locator service which allows other entities affiliated with the BSAA service to be aware of the existence of new locations/NSPs or changes in an existing location/NSP. The global updater stage 740 would be triggered automatically upon a change in status of a location, the provisioning of a new location, or a change in fundamental addresses (IP, MAC etc.) of a location. The updater stage 740 would inform all service providers via e-mail or other means of the content of the update. As a specific follow-up to this process, BSPs are notified that a new location is provisioned in accordance with stage 745.

Anytime after locations are provisioned and active, the BSAA service can start metering them (stage 750). The metering of usage begins when an end customer is authenticated and accepts the rates and policies for the location from which the session will be run. Metering involves starting, stopping and then gathering session information for any users at a particular location.

After any actual usage, the BSAA service allows reports to be run by the NSP (stage 755). The usage reports may be run online and may include filters for date ranges and geographic locations (broad, such as a city or narrow such as by SLN). The BSAA service enables NSPs to manage their accounts online (stage 760) which would include viewing of invoices, paying online, viewing payment history, requesting account adjustments etc. Periodically, and when required, the BSAA service performs settlement for the NSP/BSP (stage 765) constituting the end of the business cycle for that billing period. The settlement stage 765 involves calculate the monies owed to the NSP based on the contractual agreement with the NSP and based on the rated usage and payment collection from the BSPs.

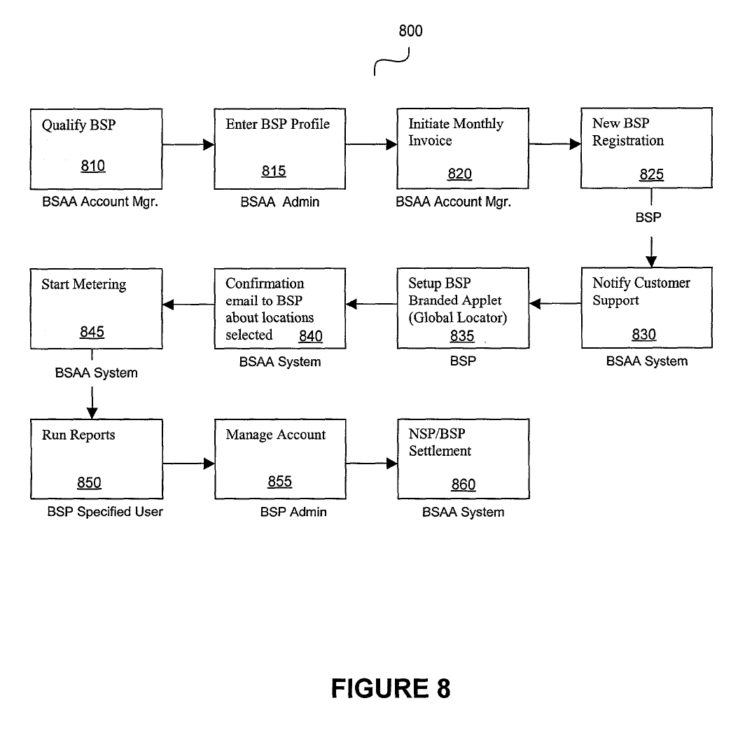

FIG. 8 is a flow diagram of the BSP business process according to one or more embodiments of the invention. The BSP business process 800 describes roughly how a BSP becomes affiliated with a BSAA service and what business cycle the BSP can expect thereafter. Process 800 also shows who would be ideally suited to executing each stage of the process. First, for an BSP to become affiliated with the BSAA service, it must Qualify (stage 810). Qualifying a BSP is function performed by a BSAA service account manager. Qualifying a BSP involves a sales approach (such as call or visit) by a salesman or account manager in the BSAA service. The account manager then evaluates the ability of the BSP to operate in the environment controlled by and with the entities managed by the BSAA service. After such an evaluation, the BSP and BSAA service enter into a contractual agreement, placing it thereafter into “affiliation” with the BSAA service.

After becoming contractually affiliated with the BSAA service, the BSP's profile is entered (stage 815). A new BSP record can be created in the database, and a message sent to the BSP regarding login/updating procedures with respect to their profile record. The BSP can thereafter enter information into its profile using the established record and/or this information can be updated by the account manager at the BSAA service. The BSP must provide the retail rate(s) for its service, the format and transfer instructions for call detail records, and settlement information. The BSP profile would include information about how to authenticate end customers. The BSP profile would also include information about various kinds of charges that it desires to implement, such as connection charges (those charges related to obtaining actual service), proxy authorization charges (charges related to the handling or proxy of authentication and accounting requests) and event charges (one-time charges related to a particular event, like an overdraft). The BSP profile also includes “account” administration for adding/deleting/editing users and installers of locations which are provisioned. Account information for users and installers include contact information, usernames, login IDs, passwords, security questions and answers and so on.

Once a BSP profile is entered into the BSAA service system, periodic invoicing can be initiated (stage 820). The invoices will include line items for monthly fixed charges for the following/current billing period and usage charges for the current billing period. Invoices may also contain past payment and late payment information.

At anytime, a non-solicited BSP should have a means of registering with the BSAA service when needed or desired (stage 825). The new BSP wishing to qualify would forward basic information to a BSAA account manager which would then qualify the NSP or not qualify the NSP. If a BSP is qualified, stage 825 would include a repetition of stages 815 and 820 for the newly qualified BSP. The recursive procedure implicit in a new unsolicited registration is not explicit in FIG. 8 but should be evident to one of skill in the art in light of the above description. Stage 830 in the business process notifies customer support at the BSAA service that a new BSP has become affiliated, allowing customer support to access profile information relevant to the BSP in order to better service them.

Particular to the BSP business process 800 is stage 835 which functions to provide a means of branding the BSP out to the locations. An applet or other automated mechanism that allows a BSP to insert its own marketing/branding information (such as logos, titles, graphics etc.) such that an end customer belonging to the BSP can download it. This “brands” the service being accessed as if it were actually provided by the BSP rather than the NSP or SLN. The created applet is stored at a location accessible via HTTP or even FTP (File Transfer Protocol) such that the customer downloads it in the computer system or other device being used to access service, preferably automatically upon authentication. The applet filters locations based on rules and filters defined by the BSP such as ‘do not show location belonging to NSP X′ or ‘do not show locations with less than T1 access”.

Then, according to stage 840, a confirmation e-mail or other such message is sent to the BSP about locations selected. Rules and filters are set up by BSP admin and the BSP location database is generated based on the specified filters. The locations that meet the filter criteria are emailed to BSP admin as a confirmation of applied rule-set.

At any time after locations are selected locations must be in BSP's location database so that the end-customers only view and logon at the locations that pass the rule-set. Once a user establishes a login, metering can start (stage 845). The metering of usage begins when an end customer is authenticated and accepts the rates and policies for the location from which the session will be run. Metering involves starting, stopping and then gathering session information for any users at a particular location.

After any actual usage, the BSAA service allows reports to be run by the BSP (stage 850). The usage reports may be run online and may include filters for date ranges and geographic locations (broad, such as a city or narrow such as by SLN and by BSP and by end customer). The BSAA service enables NSPs to manage their accounts online (stage 855) which would include viewing of invoices, paying online, viewing payment history, requesting account adjustments etc. Periodically, and when required, the BSAA service performs settlement for the NSP/BSP (stage 860) constituting the end of the business cycle for that billing period. The settlement stage 860 involves calculate the monies owed to the NSP based on the contractual agreement with the NSP and based on the rated usage and payment collection from the BSPs.

Although the present invention has been described in detail with reference to the disclosed embodiments thereof, those skilled in the art will appreciate that various substitutions and modifications can be made to the examples described herein while remaining within the spirit and scope of the invention as defined in the appended claims.

What is claimed is:

1. A method of managing usage of network services, comprising:
providing an access function to end customers such that said end customers can access said services at any arbitrary location within a set of affiliated locations;
aggregating in a periodic and real-time fashion, the access of said services by all end customers at all said affiliated locations;
billing said service providers based upon defined delineating of said aggregated access; and
settling between service providers fees and charges resulting from said billing.

2. A method according to claim 1 further comprising:
affiliating said service providers such that they are capable of being managed.

3. A method according to claim 1 wherein said network services include wireless internet access.

4. A method according to claim 1 wherein said affiliated locations include Single Location Networks.

5. A method according to claim 1 wherein said service providers include billing service providers (BSPs) and network service providers (NSPs).

6. A method according to claim 1 further comprising:
reporting to selected service providers certain selected events during said access, said aggregation, said billing, and said settlement.

7. A method according to claim 1 further comprising:
providing support and help to said service providers and said end customers during said access, said billing and said settlement.

8. A method according to claim 1 wherein providing an access function includes:
determining whether a given end customer has an account granting said access to said services;
if said given end customer does not have an account, then signing up said given end customer with an account granting said access; and
authenticating said end customer such that said end customer is granted access to use said network services.

9. A method according to claim 8 wherein said determining, signing up and authenticating may be performed at any of said affiliated locations.

10. A method according to claim 1 wherein aggregating includes:
tracking the usage of each of said end customers at any locations from which service is accessed;
aggregating by user and by location said tracked usages; and
providing relevant records of said aggregated tracked usages to said service providers.

11. A method according to claim 1 wherein billing includes:
calculating the net tracked usages for a given service provider; and
presenting said given service provider with an invoice based upon said calculated usage.

12. A method according to claim 1 wherein said settling includes:
collecting fees and charges from said BSPs;
paying from said collected fees said NSPs; and
collecting transaction fees and other charges from both BSPs and NSPs in exchange for said managing.

13. A method according to claim 1 wherein said affiliated locations include roaming network locations.

14. A system for managing usage of network services, comprising:
an access mechanism
an aggregation mechanism
a billing mechanism; and
a settlement mechanism.

15. A system according to claim 14 further comprising:
affiliation mechanism for service providers such that they are capable of being managed.

16. A system according to claim 14 wherein said network services include wireless internet access.

17. A system according to claim 14 wherein said affiliated locations include single location networks.

18. A system according to claim 14 wherein said service providers include billing service providers (BSPs) and network service providers (NSPs).

19. A system according to claim 14 further comprising:
a reporting mechanism providing reports to selected service providers certain selected events during said access, said aggregation, said billing, and said settlement.

20. A system according to claim 14 further comprising:
a support mechanism to aid said service providers and said end customers during said access, said billing and said settlement.

21. A system according to claim 14 wherein said access mechanism is configured to:
determine whether a given end customer has an account granting said access to said services;
if said given end customer does not have an account, then sign up said given end customer with an account granting said access; and
authenticate said end customer such that said end customer is granted access to use said network services.

22. A system according to claim 21 wherein said access mechanism may be distributed at any of said affiliated locations.

23. A system according to claim 14 wherein said aggregation mechanism is configured to:
track the usage of each of said end customers at any locations from which service is accessed;
aggregate by user and by location said tracked usages; and
provide relevant records of said aggregated tracked usages to said service providers.

24. A system according to claim 14 wherein said billing mechanism is configured to:
calculate the net tracked usages for a given service provider; and
present said given service provider with an invoice based upon said calculated usage.

25. A system according to claim 14 wherein said settlement mechanism is configured to:
collect fees and charges from said BSPs;
pay from said collected fees said NSPs; and
collect transaction fees and other charges from both BSPs and NSPs in exchange for said managing.

26. A system according to claim 14 wherein said affiliated locations include roaming network locations.

27. A system comprising:
a billing, settlement, access and aggregation (BSAA) service configured to manage access to network services;
a plurality of service providers, said service providers providing a combination of virtual and actual types of said network services; and
a plurality of end customers, said end customers accessing said network services said at arbitrary affiliated locations.

28. A system according to claim 27 wherein said service providing actual network services are network service providers.

29. A system according to claim 28 wherein said service providers providing virtual network services are billing service providers, said billing service providers utilizing with network service providers who provide the actual network service, which is packaged as said virtual network services, to its end customers, said utilizing done via said BSAA service.

30. A system according to claim 27 wherein said network services include wireless internet access.

31. A system according to claim 27 wherein said affiliated locations include single location networks.

32. A system according to claim 27 wherein said affiliated locations include roaming network locations.

33. A system according to claim 27 further comprising:
a reporting mechanism providing reports to selected service providers certain selected events during said access, said aggregation, said billing, and-said settlement.

34. A system according to claim 27 further comprising:
a support mechanism to aid said service providers and said end customers during said access, said billing and said settlement.

35. A system according to claim 28 wherein said BSAA service is further configured to:
determine whether a given end customer has an account granting said access to said services;
if said given end customer does not have an account, then sign up said given end customer with an account granting said access; and
authenticate said end customer such that said end customer is granted access to use said network services.

36. A system according to claim 28 wherein said BSAA service may be distributed at any of said affiliated locations.

37. A system according to claim 27 wherein said BSAA service is further configured to:
track the usage of each of said end customers at any locations from which service is accessed;
aggregate by user and by location said tracked usages; and
provide relevant records of said aggregated tracked usages to said service providers.

38. A system according to claim 27 wherein said BSAA service is further configured to:
calculate the net tracked usages for a given service provider; and
present said given service provider with an invoice based upon said calculated usage.

39. A system according to claim 27 wherein said BSAA service is further configured to:
collect fees and charges from said BSPs;
pay from said collected fees said NSPs; and
collect transaction fees and other charges from both BSPs and NSPs in exchange for said managing.
